(19) United States
(12) Patent Application Publication
(10) Pub. No.: US 2026/0223158 A1
(43) Pub. Date: Jul. 30, 2026

(54) ADAPTIVE BUFFER OCCUPANCY THRESHOLD FOR STAS

(71) Applicant: Cypress Semiconductor Corporation, San Jose, CA (US)

(72) Inventors: Avik Santra, Irvine, CA (US); Rakesh Taori, McKinney, TX (US)

(73) Assignee: Cypress Semiconductor Corporation, San Jose, CA (US)

(21) Appl. No.: 19/039,655

(22) Filed: Jan. 28, 2025

(51) Int. Cl. H04W 74/02; H04W 24/08; H04W 74/00

(52) U.S. Cl. CPC H04W 74/02; H04W 24/08; H04W 74/002

(57) ABSTRACT

Methods and systems for adaptive occupancy threshold for STAs. The disclosed method includes, among other things, obtaining a plurality of transmission telemetry, wherein each transmission telemetry corresponds to a STA of a plurality of STAs in communication with an access point (AP), determining a plurality of operational conditions of the AP, generating, based on the plurality of transmission telemetry and the operation conditions of the AP, a plurality of first occupancy thresholds, and causing each STA of the plurality of STAs to apply a corresponding first occupancy threshold to a first buffer of a respective STA.

### TECHNICAL FIELD

This disclosure relates to access point devices, and, more specifically, to adaptive occupancy threshold for STAs.

### BACKGROUND

Access point devices in wireless networks play a crucial role in enabling wireless communication between a variety of client devices, also known as STAs. They serve as vital bridges between these stations and a wired network, typically based on Ethernet. Secure communication is essential for protecting data in wireless networks, which are more vulnerable to attacks. Encryption makes it difficult for attackers to intercept and read transmitted data, even if they capture it.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary illustration of a wireless network that has an access point device and one or more STAs, in accordance with implementations of the present disclosure.

FIG. 2 illustrates a set of interactions between one or more STAs in the wireless network and the access point device in the wireless network, in accordance with implementations of the present disclosure.

FIG. 3 illustrates a set of interactions between one or more STAs in the wireless network and the access point device in the wireless network, in accordance with implementations of the present disclosure.

FIG. 4 illustrates a set of interactions between one or more STAs in the wireless network and the access point device in the wireless network, in accordance with implementations of the present disclosure.

FIG. 5 depicts a flow diagram of an example method for adaptive occupancy threshold for STAs, in accordance with implementations of the present disclosure.

FIG. 6 depicts a flow diagram of another example method for adaptive occupancy threshold for STAs, in accordance with implementations of the present disclosure.

### DETAILED DESCRIPTION

Aspects of the present disclosure relate to adaptive occupancy threshold for station devices (STAs). An access point (AP) is designed to facilitate wireless connectivity for a variety of client devices, also known as stations devices. Each STA performs data transmission to the AP, called uplink data transmission. Data transmission from the AP to the STA is called downlink data transmission. For data transmission, APs and STAs store data packets temporarily in memory buffers located in the AP and STA devices. Typically, each STA maintains an uplink buffer for storing outgoing data packets awaiting transmission to the AP and a downlink buffer for storing incoming data packets received from the AP. When an occupancy of the uplink buffer reaches or exceeds a predetermined threshold (e.g., uplink occupancy threshold), the STA sends a Buffer Status Report (BSR) signal, including the buffer occupancy, to the AP. The buffer occupancy refers to an amount of stored data relative to the total buffer size, which represents the percentage of the memory buffer filled with data packets.

Upon receiving the BSR signal, the AP adjusts uplink data transmission for the STA by allocating time periods during which the STA can transmit data packets to the AP. The AP can increase the frequency or duration of these transmission opportunities to allow the STA to transmit more buffered data packets. STAs can configure the threshold for either buffer as either a static value or dynamically adjust the threshold based on factors including traffic type, expected data volume, and application requirements. Configurable thresholds allow STAs to notify the AP before the STA buffers become full, enable the AP to manage network resources efficiently, and permit STAs to set different thresholds for applications with different delay requirements.

However, this creates inherent delays in both uplink and downlink data transmission as AP actions depend on receiving BSR notifications. Static thresholds fail to handle varying network conditions and diverse application requirements. The BSR indicating only buffer occupancy in the STA memory prevents optimal resource allocation by the AP without knowledge of specific application requirements.

Aspects and embodiments of the present disclosure address these and other limitations of the existing technology by using machine learning to generate a recommended occupancy buffer for one or more buffers of each STA of a wireless network. In some embodiments, an AP of the wireless network requests transmission telemetry (e.g., throughput, radio access capability, packet loss probability, jitter, fairness, and data formats) for each STA of the wireless network. Each STA of the wireless network collects its transmission telemetry and transmits it to the AP. The AP obtains its operational conditions (e.g., network loading, channel conditions, overlapping basic service set (OBSS) loading) which characterizes a current state of the wireless network. The AP, using a machine learning (ML) model, generates, for each STA of the wireless network, a recommended uplink occupancy threshold for an uplink buffer of a respective STA. The AP transmits the uplink recommended occupancy threshold for the uplink buffer of the respective STA to the respective STA to update its uplink buffer with the recommended uplink occupancy threshold.

In some embodiments, a STA of the wireless network (e.g., a requesting STA) requests transmission telemetry for other STA(s) of the wireless network (e.g., receiving STAs) and operational conditions of the wireless network from the AP. Each of the receiving STAs collects its transmission telemetry and transmits it to the requesting STA. The AP obtains its operational conditions and transmits it to the requesting STA. The requesting STA, using the ML model, generates a recommended uplink occupancy threshold for an uplink buffer of the requesting STA and updates its uplink buffer with the recommended uplink occupancy threshold.

In some embodiments, an AP transmits data to one or more STAs of the wireless network (e.g., receiving STAs). The receiving STAs collect reception telemetry (e.g., received signal strength indicator (e.g., RSSI) and quality metrics (e.g., signal-to-noise ratio, bit error rate, and packet loss rate)) and transmits it to the AP. The AP, using the ML model, generates, for each of the receiving STAs, a recommended downlink occupancy threshold for a downlink buffer of a respective STA. The AP transmits the downlink recommended occupancy threshold for the downlink buffer of the respective STA to the respective STA to update its downlink buffer with the recommended downlink occupancy threshold.

Aspects of the present disclosure overcome these deficiencies and others by proactively adjusting the occupancy threshold for buffers of each STA thereby improving buffer management which increases efficiency in resource allocation.

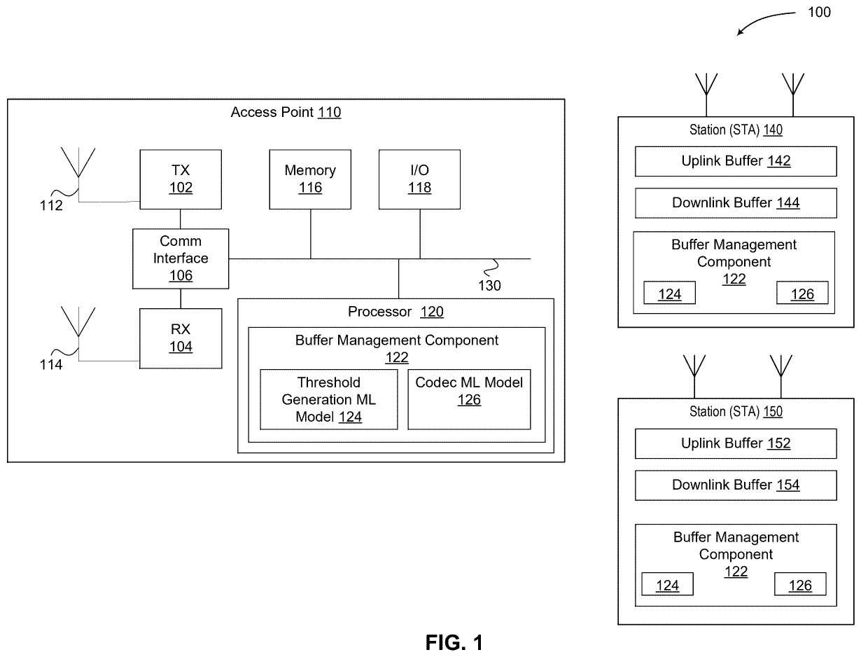

FIG. 1 is a block diagram of an exemplary illustration of a wireless network 100 that has one or more STAs, in accordance with implementations of the present disclosure. The wireless network 100 may be a wireless local area network (WLAN), wireless wide area network (WWAN), wireless metropolitan area network (WMAN), wireless personal area network (PAN), and so on. The wireless network 100 may include a STA (STA) operating as an AP 110. The wireless network 100 may include one or more client devices, such as STA (STA) 140 and STA (STA) 150. STA 140 and/or STA 150 may establish a wireless connection with the AP 110. The STA 140 includes multiple buffers (e.g., an uplink buffer 142 and a downlink buffer 144) enabling bidirectional communication by managing both outgoing and incoming data traffic between the STA 140 and AP 110. The STA 150 includes multiple buffers (e.g., an uplink buffer 152 and a downlink buffer 154) enabling bidirectional communication by managing both outgoing and incoming data traffic between the STA 150 and AP 110. The uplink buffer (e.g., uplink buffer 142 and uplink buffer 152) stores data packets waiting to be transmitted to the AP 110 and the downlink buffer (e.g., downlink buffer 144 and downlink buffer 154) that stores data packets received from the AP 110. The wireless connection provided by AP 110 may use any band, such as the 2.4 GHz regulatory domain, the 5 GHz domain, the 60 GHz domain, or any other frequency band.

In at least some embodiments, AP 110 includes, but is not limited to, a transmitter 102 (e.g., a PAN transmitter), a receiver 104 (e.g., a PAN receiver), a communications interface 106, a transmitter (TX) antenna 112 coupled to the transmitter 102, a receiver (RX) antenna 114 coupled to the receiver 104, a memory 116, one or more input/output (I/O) devices 118 (such as a display screen, a touch screen, a keypad, and the like), and a processor 120. These components can all be coupled to a communications bus 130. In some embodiments, aspects of the communication interface 106 work with the processor 120 to perform operations or functions as a processing device of the AP 110. In some embodiments, there is a single antenna and multiplexing logic to switch the use of the antenna between the transmitter 102 and receiver 104. In various embodiments, front end components such as the transmitter 102, the receiver 104, the communication interface 106, and the one or more antennas (e.g., TX antenna 112 and/or RX antenna 114) described herein within various devices are adapted with or configured for WLAN and PAN-based frequency bands, e.g., Bluetooth® (BT), BLE, Wi-Fi®, Zigbee®, Z-wave®, and the like.

Processor 120 may include a buffer management component 122. The buffer management component 122 is configured to adaptive occupancy threshold for STAs, as will be discussed in further details below.

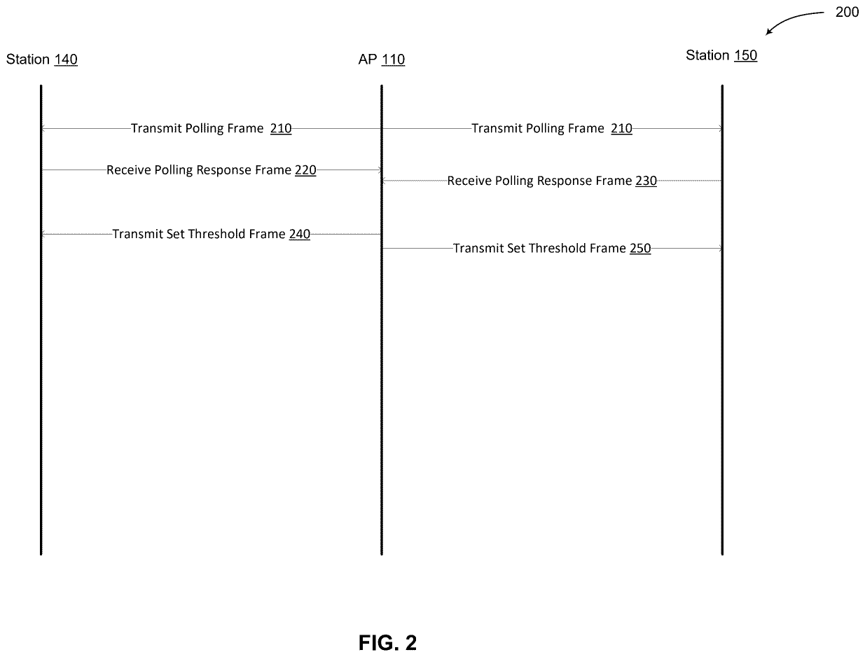

With reference to FIG. 2, which illustrates a set of interactions 200 between one or more STAs (e.g., STA 140 and/or 150) and the AP 110 of the wireless network 100, prior to interaction 210, the buffer management component 122 of the AP 110 generates a polling frame. At interaction 210, the buffer management component 122 of the AP 110 transmits the polling frame to STA 140 and STA 150. The polling frame includes a request for one or more transmission-related metrics (e.g., transmission telemetry) of a receiving STA (e.g., STA 140 and/or STA 150).

In response to receive the polling frame, each STA (e.g., STA 140 and STA 150) collects transmission telemetry and transmits the transmission telemetry to the AP 110. In some embodiments, each STA (e.g., STA 140 and STA 150) includes an encoder-decoder machine learning model (e.g., a codec ML model 126) configured to apply compression or decompression operation in a sequential order, such as a time-distributed encoder-decoder neural network model. Accordingly, the codec ML model 126 of each STA (e.g., STA 140 and/or 150) receives the transmission telemetry and outputs a latent representation of the transmission telemetry. Thus, rather than the STA(s) (e.g., STA 140 and 150) transmitting their transmission telemetry, the STA(s) (e.g., STA 140 and 150) transmits a latent representation of their transmission telemetry to the AP 110. In some embodiments, telemetry (e.g., transmission and/or reception telemetry) and/or latent representation of the telemetry of one or more STAs may be used to update the codec ML model 126 using back-propagation.

The transmission telemetry includes one or more metrics (e.g., throughput, radio access capability, packet loss probability, jitter, fairness, and data formats) that characterize STA performance and capabilities. Throughput measures the actual data transfer rate achieved by the STA during communication with the AP. Radio access capability defines the features and functions supported by the STA, including protocols, frequencies, and modulation schemes. Packet loss probability indicates the likelihood of data packets being lost during transmission between the STA and AP. Jitter represents the variation in packet delivery timing, which affects the stability and predictability of communications. Fairness measures how equitably the STA accesses network resources compared to other stations in the network. Data formats specify the types of data structures and encodings that the STA can process and transmit. It should be noted that other metrics that affect transmission are contemplated.

At interaction 220, the buffer management component 122 of AP 110 receives a polling response frame from STA 140 which includes the transmission telemetry (or latent representation of the transmission telemetry) of STA 140. At interaction 230, the buffer management component 122 of AP 110 receives a polling response frame from STA 150 which includes the transmission telemetry (or latent representation of the transmission telemetry) of STA 150. If the AP 110 receives the latent representation of the transmission telemetry of STA 140 and the latent representation of the transmission telemetry of STA 150, the codec ML model 126 of the buffer management component 122 of AP 110 combines the latent representation of the transmission telemetry of all STAs (e.g., STA 140 and STA 150) and reconstructs the transmission telemetry of each STA (e.g., the transmission telemetry of STA 140 and the transmission telemetry of STA 150, respectively).

The buffer management component 122 of AP 110 obtains a plurality of operational conditions of the AP 110 (e.g., network loading, channel conditions, overlapping basic service set (OBSS) loading) characterizes a current state of the network environment. Network loading indicates the current utilization level of the resources of the AP, including the amount of traffic being handled and the number of connected STAs. Channel conditions describe the quality and characteristics of the wireless medium, including interference levels, noise, and signal strength in the operating channel of the AP. Overlapping basic service set (OBSS) loading represents the impact of other nearby wireless networks operating on the same or adjacent channels, which can affect the ability of the AP to effectively serve its connected STAs due to potential interference. It should be noted that other metrics that affect network performance are contemplated.

The buffer management component 122 of the AP 110 generates, using the transmission telemetry of the STA(s) (e.g., STA 140 and STA 150) and the plurality of operational conditions of the AP 110, a recommended occupancy threshold (e.g., a recommended uplink occupancy threshold) of an uplink buffer of each STA (e.g., uplink buffer 142 of STA 140 and uplink buffer 152 of STA 150). The uplink occupancy threshold may be a value that triggers when an uplink buffer of a STA should send a BSR signal to the AP.

In some embodiments, the buffer management component 122 may include a threshold generation machine learning (ML) model (e.g., threshold generation ML model 124) trained to generate an occupancy threshold for each STA for which a transmission telemetry or reception telemetry is received. The threshold generation ML model 124 may be a multilayer perceptron (MLP). In some embodiments, the MLP of the threshold generation ML model 124 may be updated by back-propagating generated occupancy thresholds. The threshold generation ML model 124 may further include a linear function (e.g., rectified linear unit (ReLU) activation) and/or a stochastic gradient descent method (e.g., Adam optimization).

The threshold generation ML model 124 may be configured to receive a variable number of inputs corresponding to a number of STA(s) (e.g., variable number of transmission telemetry or reception telemetry). In some embodiments, the threshold generation ML model 124 is configured to receive a large number of inputs from multiple STA(s), thus any input that does not receive an input from a STA is ignored using the masking mechanism. In some embodiments, the threshold generation ML model 124 may be configured to utilize features that are independent of the number of STA(s) when generating uplink occupancy threshold, such as, average throughput, total network loading, and maximum packet loss probability. In some embodiments, the threshold generation ML model 124 may use various normalization techniques, such a scaler (e.g., min-max scaler or standard scaler), to normalize the inputs to ensure fair contribution from each STA, regardless of the number of STA(s). In other embodiments, multiple threshold generation ML model(s) 124 may be trained and used, in which each threshold generation ML model 124 is configured to receive input from a specific number of STA(s). Accordingly, an additional ML model may be used to select an appropriate threshold generation ML model 124 that reflects a number of STA(s) within the wireless network 100.

The threshold generation ML model 124 may be trained to increase throughput by allocating resources based on real-time needs. The threshold generation ML model 124 may be trained to decrease packet delay by optimizing resource allocation. The threshold generation ML model 124 may be trained to decrease packet loss rate by managing buffer levels and resource allocation across STA(s). The threshold generation ML model 124 may be trained to predict an optimal uplink occupancy threshold to avoid uplink buffer overflow. The threshold generation ML model 124 may be trained to consider the transmission telemetry across the STA(s) to achieve fairer resource allocation, which in some instances may favor a specific STA that send more frequent BSR signals. The threshold generation ML model 124 may be trained to improve channel utilization through efficient resource allocation The threshold generation ML model 124 may be trained may increase fairness among the STA(s) by analyzing the needs of the STAs.

Depending on the embodiment, the threshold generation ML model 124 and the codec ML model 126 may be trained together using a combined loss function. The loss function may include, for example, a mathematical expression (or term) for reconstruction error, occupancy threshold error, and regularization. As a result, the threshold generation ML model 124 and the codec ML model 126 may learn to cooperate and improve overall performance in generation uplink and downlink occupancy threshold. Additionally, the threshold generation ML model 124 and/or the codec ML model 126 may be periodically retrain (using adjusted model parameters) every predetermined number of packets to adjust to changes in network conditions of wireless network 100. Thus, the threshold generation ML model 124 and/or the codec ML model 126 may improve its ability to compress, reconstruct, and predict uplink and downlink occupancy threshold.

At interaction 240, the buffer management component 122 of the AP 110 transmits, to STA 140, a set threshold frame which includes the recommended uplink occupancy threshold for the uplink buffer 142 of STA 140. As a result, STA 140 updates uplink buffer 142 with the recommended uplink occupancy threshold. At interaction 250, the buffer management component 122 of the AP 110 transmits, to STA 150, a set threshold frame which includes the recommended uplink occupancy threshold for the uplink buffer 152 of STA 150. As a result, STA 150 updates uplink buffer 152 with the recommended uplink occupancy threshold.

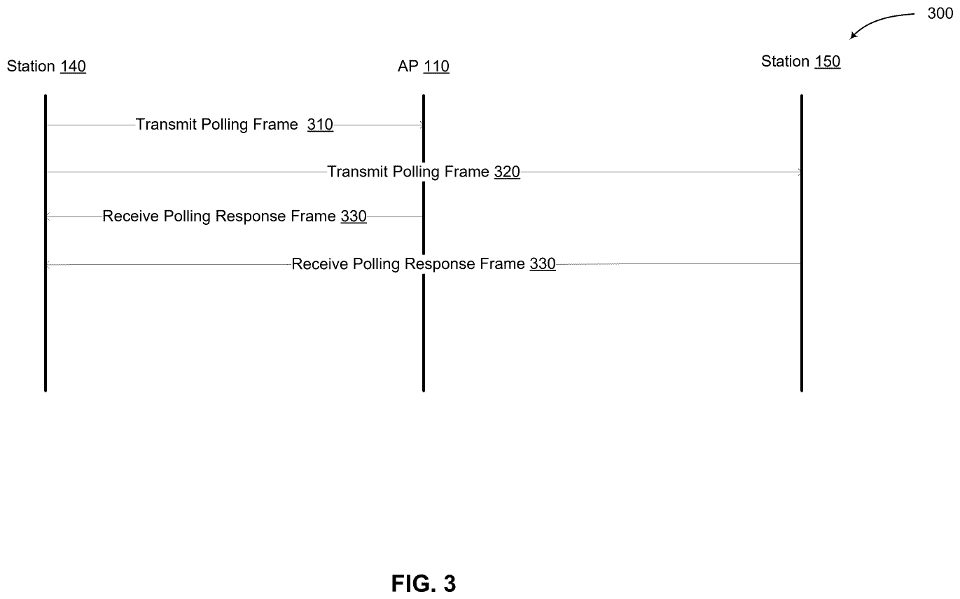

With reference to FIG. 3, which illustrates a set of interactions 300 between one or more STAs (e.g., STA 140 and/or 150) and the AP 110 of the wireless network 100, prior to interaction 310, the buffer management component 122 of the STA 140 generates a polling frame. At interaction 310, the buffer management component 122 of the STA 140 transmits the polling frame to AP 110 and STA 150. At interaction 320, the buffer management component 122 of the STA 140 transmits the polling frame to STA 150.

The AP 110, in response to the polling frame, transmits a plurality of operational conditions (or latent representation of the plurality of operational conditions) of the AP 110 to the STA 140. As previously described, the latent representation of the plurality of operational conditions of the AP 110 may be generated using codec ML model 126 of the AP 110. At interaction 330, the STA 140 receives a polling response frame from AP 110 which includes the plurality of operational conditions (or latent representation of the plurality of operational conditions) of the AP 110. The STA 150, in response to the polling frame, transmits transmission telemetry (or latent representation of the transmission telemetry) of STA 150 to the STA 140. As previously described, the latent representation of the transmission telemetry of the STA 150 may be generated using codec ML model 126 of the STA 150. At interaction 340, the STA 140 receives a polling response frame from STA 150 which includes the transmission telemetry (or latent representation of the transmission telemetry) of STA 150. Additionally, the buffer management component 122 of STA 140 identifies transmission telemetry of the STA 140.

If the AP 110 receives the latent representation of the transmission telemetry of STA 140 and the latent representation of the transmission telemetry of STA 150, the codec ML model 126 of the buffer management component 122 of AP 110 reconstructs the transmission telemetry of the STA 150 and the plurality of operational conditions of the AP 110.

The buffer management component 122 of the STA 140, using the transmission telemetry of the STA 140, the transmission telemetry of the STA 150, and the plurality of operational conditions of the AP 110, generates an uplink occupancy threshold for the STA 140 (e.g., a recommended uplink occupancy threshold). Similar to the threshold generation ML model of the buffer management component 122 of the AP 110, the uplink occupancy threshold for the STA 140 is generated using the threshold generation ML model of the buffer management component 122 of the STA 140. The buffer management component 122 of the STA 140 updates an existing uplink occupancy threshold of the uplink buffer 142 with the recommended uplink occupancy threshold.

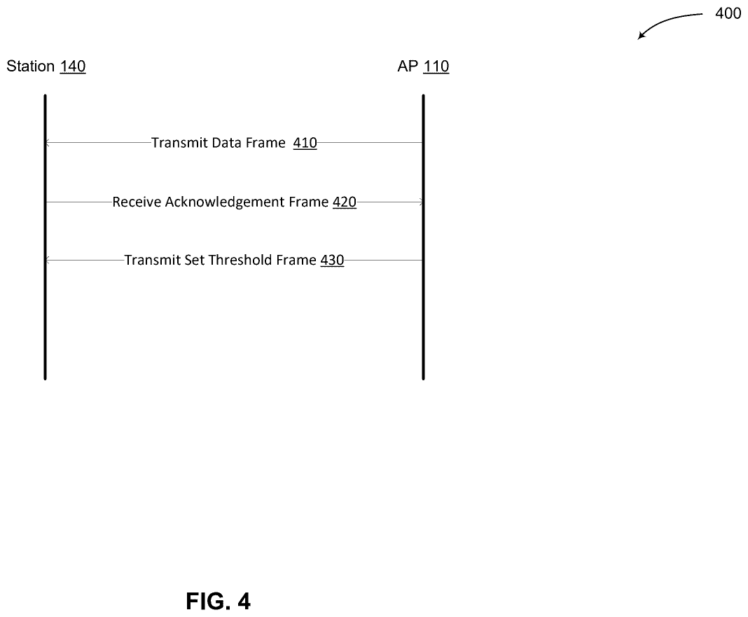

With reference to FIG. 4, which illustrates a set of interactions 400 between a STA (e.g., STA 140) and the AP 110 of the wireless network 100. At interaction 410, the AP 110 transmits a data frame to STA 140. In response to receiving a data frame, the STA 140 computes reception-related telemetry (e.g., reception telemetry). The reception telemetry can include, for example, a received signal strength indicator (e.g., RSSI) and quality metrics (e.g., signal-to-noise ratio, bit error rate, and packet loss rate). The STA 140 transmits, to the AP 110, the reception telemetry (or a latent representation of the reception telemetry). As previously described, the latent representation of the reception telemetry of the STA 140 may be generated using codec ML model 126 of the STA 140.

At interaction 420, the AP 110 receives an acknowledgement frame from STA 140 which includes the reception telemetry (or latent representation of the reception telemetry). If the AP 110 receives the latent representation of the reception telemetry of STA 140, the codec ML model 126 of the buffer management component 122 of AP 110 and reconstructs the reception telemetry of the STA 140. The buffer management component 122 of the AP 110 generates a recommended downlink occupancy threshold for the downlink buffer 144 of STA 140. At interaction 430, the buffer management component 122 of the AP 110 transmits a set threshold frame which includes the recommended downlink occupancy threshold to STA 140. As a result, the STA 140 updates downlink buffer 144 of STA 140 with the recommended downlink occupancy threshold received from the AP 110.

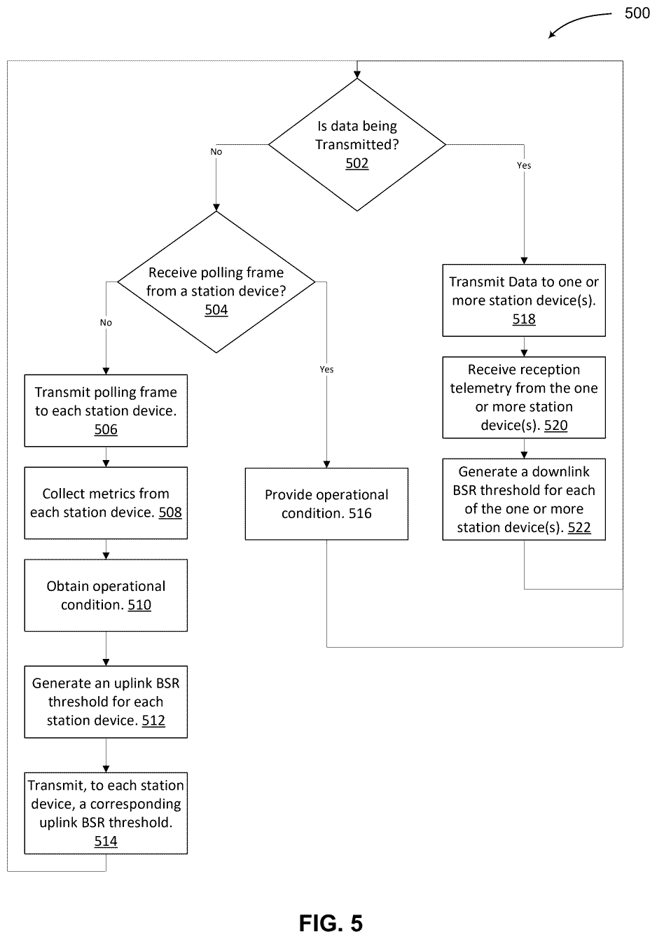

FIG. 5 is a flow diagram of a method 500 of adaptive occupancy threshold for STAs, in accordance with implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the AP 110 (e.g., processing device).

At operation 502, the processing logic determines whether data is being transmitted. If data is not being transmitted, at operation 504, the processing logic determines whether a polling frame was received from a STA. If a polling frame was not received from a STA, at operation 506, the processing logic transmits a polling frame to each STA. As previously described, the polling frame includes a request for one or more transmission-related metrics (e.g., transmission telemetry) of each STA receiving the polling frame. At operation 508, the processing logic collects, via a polling response frame, transmission telemetry from each STA. At operation 510, the processing logic obtains operational conditions (of the AP). As previously described, operational conditions refer to the current state of the network environment. At operation 512, the processing logic generates an uplink occupancy threshold (e.g., a first occupancy threshold) for each STA. As previously described, the uplink occupancy threshold is generated based on the transmission telemetry from each STA and the operational conditions. As previously described, the uplink occupancy threshold may be a value that triggers when an uplink buffer of a STA should send a BSR signal to the AP. At operation 514, the processing logic transmits, to each STA, a corresponding uplink occupancy threshold. As a result, each STA is caused to update their respective uplink buffer with their corresponding uplink occupancy threshold.

If polling frame was received from a STA, at operation 516, the processing logic provides operational conditions. As previously described, the AP provide its operational conditions to the requesting STA.

If data is not being transmitted, at operation 518, the processing logic transmits data to one or more STAs. At operation 520, the processing logic receives reception telemetry from the one or more STAs. As previously described, in response to each of the one or more STA receiving data from the AP, each of the one or more STAs transmits an acknowledgement frame including the reception telemetry. Reception telemetry can include, for example, a received signal strength indicator (e.g., RSSI) and quality metrics (e.g., signal-to-noise ratio, bit error rate, and packet loss rate). At operation 522, the processing logic generates a downlink occupancy threshold (e.g., a second occupancy threshold) for each of the one or more STAs. Depending on the embodiment, the processing logic transmits, to each STA, a corresponding downlink occupancy threshold. As a result, each STA is caused to update their respective downlink buffer with their corresponding downlink occupancy threshold.

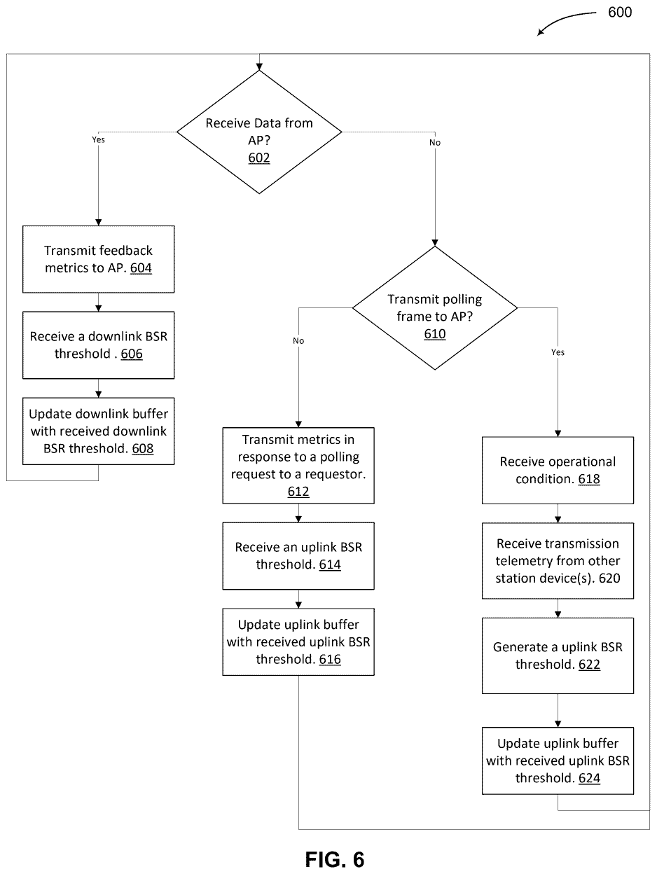

FIG. 6 is a flow diagram of a method 600 of adaptive occupancy threshold for STAs, in accordance with implementations of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the STA 140 or the STA 150 (e.g., processing device).

At operation 602, the processing logic determines whether data is received from an AP.

If data is received from the AP, at operation 604, the processing logic transmits reception telemetry to the AP. At operation 606, the processing logic receives a downlink occupancy threshold. As previously described, the AP generates the downlink occupancy threshold for each STA that was transmitted data and transmitted to the STAs. At operation 608, the processing logic updates downlink buffer with the received downlink occupancy threshold.

If data is not received from the AP, at operation 610, the processing logic determines whether a polling frame is transmitted to the AP. If a polling frame is not transmitted to the AP, at operation 612, the processing logic transmits metrics in response to a polling frame to a requestor (e.g., another STA or AP). At operation 614, the processing logic receives an uplink occupancy threshold. At operation 616, the processing logic update uplink buffer with received uplink occupancy threshold. If a polling frame is transmitted to the AP, at operation 618, the processing logic receives operational conditions from the AP. At operation 620, the processing logic receives transmission telemetry from other STAs. At operation 622, the processing logic generates an uplink occupancy threshold. At operation 624, the processing logic updates uplink buffer with received uplink occupancy threshold.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. An access point (AP), comprising:
a processor, wherein the processor is to perform operations comprising:
obtaining a plurality of transmission telemetry, wherein each transmission telemetry corresponds to a station device (STA) of a plurality of STAs in communication with the AP;
determining a plurality of operational conditions of the AP;
generating, based on the plurality of transmission telemetry and the operation conditions of the AP, a plurality of first occupancy thresholds, wherein each STA of the plurality of STAs has a corresponding first occupancy threshold; and
causing each STA of the plurality of STAs to apply a corresponding first occupancy threshold to a first buffer of a respective STA.

2. The AP of claim 1, wherein the plurality of transmission telemetry is obtained in response to transmitting a polling frame to the plurality of STAs.

3. The AP of claim 1, wherein each transmission telemetry includes at least one of: throughput, radio access capability, packet loss probability, jitter, fairness, or data formats.

4. The AP of claim 1, wherein the plurality of operational conditions of the AP includes at least one of: network loading, channel conditions, or overlapping basic service set loading.

5. The AP of claim 1, wherein the plurality of first occupancy thresholds is generated using a machine learning model.

6. The AP of claim 1, wherein causing each STA of the plurality of STAs to apply the corresponding first occupancy threshold to the first buffer of the respective STA comprises:
transmitting, to the respective STA, the corresponding first occupancy threshold; and
causing, the respective STA, to update an existing first occupancy threshold with the corresponding first occupancy threshold.

7. The AP of claim 1, wherein the first buffer is a buffer storing incoming data packets to be transmitted to the AP.

8. The AP of claim 1, wherein the processor is to perform operations further comprising:
transmitting data to one or more STAs of the plurality of STAs;
receiving, from each STA of the one or more STAs, reception telemetry;
generating, based at least in part on the reception telemetry of the one or more STAs, a second occupancy threshold; and
causing each STA of the one or more STAs to apply a corresponding second occupancy threshold to a second buffer of a respective STA.

9. The AP of claim 8, wherein the second buffer is a buffer storing incoming data packets received from the AP.

10. A method comprising:
obtaining a plurality of transmission telemetry, wherein each transmission telemetry corresponds to a STA of a plurality of STAs in communication with an access point (AP);
determining a plurality of operational conditions of the AP;
generating, based on the plurality of transmission telemetry and the operation conditions of the AP, a plurality of first occupancy thresholds, wherein each first occupancy threshold corresponds to a STA of the plurality of STAs; and
causing each STA of the plurality of STAs to apply a corresponding first occupancy threshold to a first buffer of a respective STA.

11. The method of claim 10, wherein each transmission telemetry includes at least one of: throughput, radio access capability, packet loss probability, jitter, fairness, or data formats.

12. The method of claim 10, wherein the plurality of first occupancy thresholds is generated using a machine learning model.

13. The method of claim 10, wherein causing each STA of the plurality of STAs to apply the corresponding first occupancy threshold to the first buffer of the respective STA comprises:
transmitting, to the respective STA, the corresponding first occupancy threshold; and
causing, the respective STA, to update an existing first occupancy threshold with the corresponding first occupancy threshold.

14. The method of claim 10, further comprising:
transmitting data to one or more STAs of the plurality of STAs;
receiving, from each STA of the one or more STAs, reception telemetry;
generating, based at least in part on the reception telemetry of the one or more STAs, a second occupancy threshold; and
causing each STA of the one or more STAs to apply a corresponding second occupancy threshold to a second buffer of a respective STA.

15. A wireless network comprising:
an access point (AP);
a plurality of first STAs; and
a second STA, wherein a processor of the second STA is to perform operations comprising:
receiving, from the plurality of first STAs, a plurality of first transmission telemetry, wherein each first transmission telemetry corresponds to a first STA of the plurality of first STAs;
receiving, from the AP, plurality of operational conditions of the AP;
determining a second transmission telemetry;
generating, based on the plurality of first transmission telemetry, the second transmission telemetry, and the operation conditions of the AP, a recommended first occupancy threshold of a first buffer of the second STA; and
updating an existing first occupancy threshold of the first buffer of the second STA with the recommended first occupancy threshold.

16. The wireless network of claim 15, wherein receiving the plurality of first transmission telemetry comprises:
generating, by the second STA, a polling frame;
transmitting the polling frame to the AP; and
causing the AP to transmit the polling frame to the plurality of first STAs; and
causing the plurality of first STAs to transmit the plurality of first transmission telemetry to the second STA.

17. The wireless network of claim 15, wherein receiving the plurality of operational conditions of the AP comprises:
generating, by the second STA, a polling frame;
transmitting the polling frame to the AP; and
causing the AP to transmit the plurality of operational conditions of the AP to the second STA.

18. The wireless network of claim 15, wherein each first transmission telemetry includes at least one of: throughput, radio access capability, packet loss probability, jitter, fairness, or data formats.

19. The wireless network of claim 15, wherein the plurality of operational conditions of the AP includes at least one of: network loading, channel conditions, or overlapping basic service set loading.

20. The wireless network of claim 15, wherein the recommended first occupancy threshold is generated using a machine learning model.
